(19) United States
(12) Patent Application Publication
(10) Pub. No.: US 2010/0139160 A1
(43) Pub. Date: Jun. 10, 2010

(54) Plant pot having soil moisture audio alarm

(76) Inventors: Richard A. Hirsh, Upper Holland, PA (US); Lai Sheung Shiu, Happy Valley (HK)

Correspondence Address: ANDREW L. NEY;Barley Snyder LLC, 1000 Westlakes Drive, Suite 275, Berwyn, PA, 19312, US

(21) Appl. No.: 12/316,162

(22) Filed: Dec. 10, 2008

(51) Int. Cl. A01G 9/02; G08B 21/20

(52) U.S. Cl. 47/66.6; 47/65.5; 47/65.6; 340/604

(57) ABSTRACT

A plant pot having a built-in soil moisture audio alarm that provides a caretaker of the plant pot with an audio alarm when the moisture in the soil in the plant pot falls below a prescribed level.

### FIELD OF THE INVENTION

The present invention relates, in general, to plant soil moisture monitoring and, in particular, to a plant pot having a low moisture audio alarm that warns a plant caretaker that a plant in the pot needs water.

### BACKGROUND OF THE INVENTION

It is well known that plants require adequate watering to survive. Many plant moisture monitoring devices are currently commercially available for plant caretakers or are disclosed in the prior art. Typically, these moisture monitoring devices are small units that plant caretakers stick into the plant soil and provide the plant caretakers with visual or audio notice of low plant soil moisture.

The commercially available or known plant soil moisture monitoring devices have a number of shortcomings. Visual alarms or warnings of low plant soil moisture require that plant caretakers have lines of sight or be in proximity to the plant to receive indications of low plant soil moisture. A plant soil moisture monitoring device that is stuck into a plant, if not aesthetically pleasing, can detract from the beauty of the plant. With beauty of the plant being of primary, if not sole, importance to plant caretakers, a plant caretaker is likely to find it necessary to remove a plant soil moisture monitoring device that is not aesthetically pleasing after conducting each moisture test and store the monitoring device till the next moisture test is conducted. The one plant soil moisture monitoring device having an audio alarm that is known to Applicant must be removed from the plant and stored away if the plant caretaker does not want to hear or be disturbed with an audio alarm at selected times, such as when sleeping.

### SUMMARY OF THE INVENTION

A plant pot having a soil moisture audio alarm, constructed in accordance with the present invention, comprises a container that is adapted to hold soil and a plant and a soil moisture audio alarm assembly mounted to the container. The soil moisture audio alarm assembly includes a soil moisture sensor, adapted to be embedded in the soil held in the container, that senses the degree of moisture of the soil and provides a moisture output signal representative of the degree of moisture of the soil. The soil moisture audio alarm assembly also includes an audio signal source for transmitting audio signals when activated and audio alarm means, responsive to signals transmitted from the audio signal source, for sounding an audio alarm. The soil moisture audio alarm assembly further includes control circuit means, responsive to the moisture output signal, for sensing the level of the moisture output signal, activating the audio signal source when the level of the moisture output signal represents the moisture of the soil falling below a prescribed threshold level, and conducting the audio signals transmitted from the audio signal source to the audio alarm means.

### BRIEF DESCRIPTION OF THE DRAWINGS

FIG. 1 is a perspective view of a plant pot having a soil moisture audio alarm constructed in accordance with the present invention.

FIG. 2 is a side view of the FIG. 1 plant pot.

FIG. 3 is a sectional view of the FIG. 2 plant pot taken along line 3-3 of FIG. 2.

FIG. 4 is a sectional view of the FIG. 3 plant pot taken along line 4-4 of FIG. 3.

FIG. 5 is a bottom view of the FIG. 2 plant pot.

FIG. 6 is a perspective schematic view of a printed circuit board that can be included in a plant pot constructed in accordance with the present invention.

### DETAILED DESCRIPTION OF THE INVENTION

Referring to the drawings, a plant pot having a soil moisture audio alarm, constructed in accordance with the present invention, includes a container 10 adapted to hold soil, represented schematically by a plurality of balls 12, and a plant 14. Container 10 may take many different forms and be made from a suitable plastic or ceramic material.

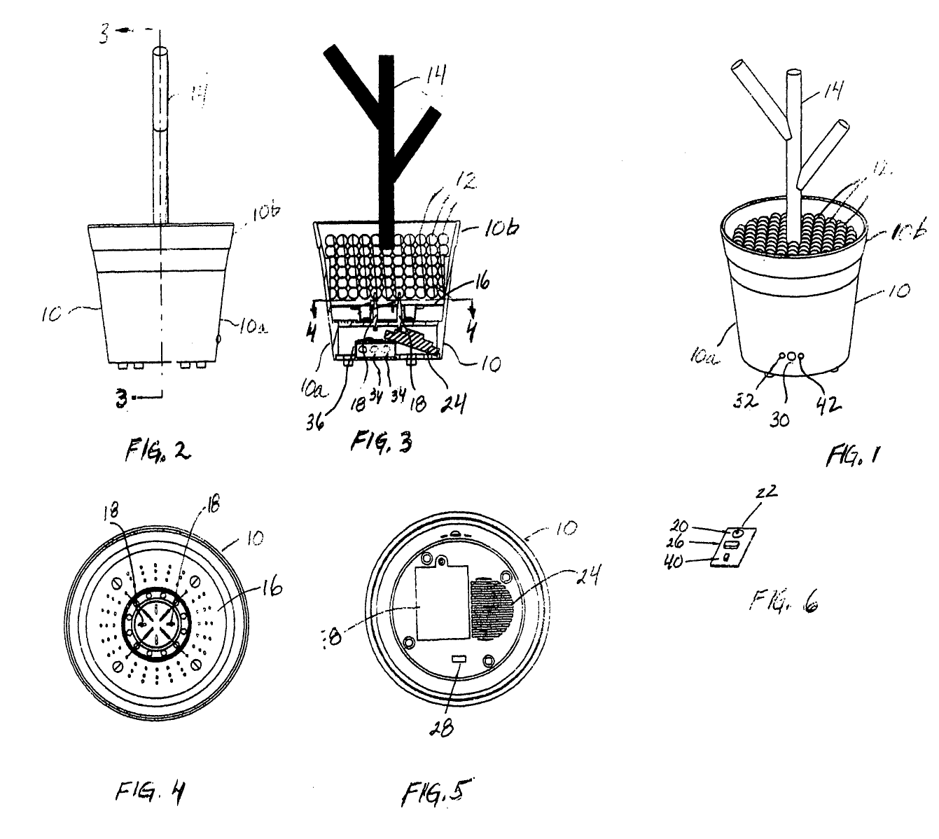

For the embodiment of the present invention being described and illustrated most clearly in FIGS. 1, 2 and 3, container 10 is composed of a first shell 10a to which a soil moisture audio alarm assembly (that is described below) is mounted and a second shell 10b fitted within the first shell that is adapted to hold soil and a plant. In this manner, the soil moisture audio alarm assembly, mounted in the first shell, is moisture-sealed from water in the soil held in the second shell. A soil drainage retainer screen 16, illustrated in FIG. 4, is spaced from the bottom of shell 10b, as shown in FIG. 3, to define a reservoir at the bottom of shell 10b for water draining from the soil if the plant has been overwatered. The drainage of water from the soil mitigates the risk of rotting of the plant roots that can result from overwatering.

A plant pot having a soil moisture audio alarm, constructed in accordance with the present invention, also includes a soil moisture audio alarm assembly mounted to shell 10a of container 10. This soil moisture audio alarm assembly includes a soil moisture sensor 18, 18 that projects through soil drainage retainer screen 16 and is adapted to be embedded in the soil, as illustrated most clearly in FIG. 3. Soil moisture sensor 18, 18 senses the degree of moisture of the soil held in shell 10b of container 10 and provides a moisture output signal representative of the degree of moisture of the soil. For the embodiment of the present invention being described and illustrated by the drawings, the portions of soil moisture sensor 18, 18 that extend through the water reservoir at the bottom of shell 10b are coated with a suitable material, so that the soil moisture sensor will not sense and be prevented from responding to water that might collect in the water reservoir. Soil moisture sensor 18, 18 may be of conventional construction and operation that includes metal probes currently available from YUE AO WU JIN HUANG FACTORY (China) Part No. 414-92486.

The soil moisture audio alarm assembly also includes an audio signal source, identified by reference numeral 20 in FIG. 6, which, when activated, transmits audio signals. Audio signal source 20, as shown in FIG. 6, may be a part of a printed circuit board 22. Audio signal source 20 may be an electronic recording of music such as the voice chip circuit that is currently available from Alpha Microelectroniic Corp (Taiwan) Model No. AM4GC0790502.

The soil moisture audio alarm assembly further includes an audio alarm means 24 which, in response to the audio signals transmitted from audio signal source 20, is energized and sounds an audio alarm that gives notice to the plant caretaker of a low soil moisture condition. Audio alarm means 24 may be a speaker such as the one that is currently available from Kam Kit Electronics., Ltd. (China) Model No. YD-57-N.

The soil moisture audio alarm assembly further includes control circuit means, identified by reference numeral 26 in FIG. 6, which, in response to the moisture output signal from moisture sensor 18, 18, sense the level of the moisture output signal, activate audio signal source 20 when the level of the moisture output signal represents the moisture of the soil falling below a prescribed threshold level, and conduct the audio signals transmitted from the audio signal source to audio alarm means 24 to sound an audio alarm that gives notice to the plant caretaker of a low soil moisture condition. Control circuit means 26 may be a main MCU (Micro Control Unit) such as the one that is currently available from Alpha Microelectroniic Corp (Taiwan) Model No. AM8EBO53A. Preferably, control circuit means 26 activate audio signal source 20 periodically, for example once every hour, rather can continuously, to conserve power. Control circuit means 26, as shown in FIG. 6, also may be part of printed circuit board 22

An ON/OFF switch 28, illustrated in FIG. 5 as being located at the bottom of shell 10a in the embodiment of the present invention being described, is connected to control circuit means 26 and serves to turn the soil moisture audio alarm assembly “ON” when in a first position and “OFF” when in a second position. ON/OFF switch 28 can be arranged with a third position that permits the plant caretaker to turn the soil moisture audio alarm assembly “ON” by closing a switch, such as a push-button switch 30 that is connected to control circuit means 26, to activate audio signal source 20 and hear the electronic recording of the audio signals transmitted from the audio signal source without soil moisture sensor 18, 18 having sensed a low soil moisture condition.

A plant pot having a soil moisture audio alarm, constructed in accordance with the present invention, preferably includes means for disabling the soil moisture audio alarm assembly during night time, so the plant caretaker is not disturbed by audio emanating from audio alarm means 24 while he or she might be sleeping. Such means include, for the embodiment of the present invention being described and illustrated by the drawings, a light sensor 32 that senses the degree of ambient light in the vicinity of the plant pot and provides a light output signal representative of the ambient light In the vicinity of the plant pot. The light output signal from light sensor 32 disables control circuit means 26 which prevents activation of audio signal sound source 20 when the light output signal from the light sensor falls below a prescribed level indicative of night time. Light sensor 32 may be a light sensor such as the one that is currently available from SUPER BRIGHT INDUSTRIAL LTD. (Taiwan) Part No. PT224C. The circuitry for disabling soil moisture audio alarm assembly may be incorporated in control circuit means 26.

For the embodiment of the present invention being described and illustrated by the drawings, a plurality of batteries 34 that provide power to the soil moisture audio alarm assembly are housed in a battery box 36. A battery box door 38, at the bottom of shell 10a and illustrated most clearly in FIG. 5, provides access to batteries 34.

A plant pot having a soil moisture audio alarm assembly that is battery powered preferably includes a low voltage detector circuit, identified by reference numeral 40 in FIG. 6, that sends a signal to control circuit means 26 when the voltage of batteries 34 drops below a prescribed level and the control circuit means, in turn, cause an indicator 42, for example an LED, shown in FIG. 1, to illuminate, either intermittently or steadily, alerting the plant caretaker of the low voltage condition and prompting the plant caretaker to change the batteries. As shown in FIG. 6, low voltage detector 40 may be part of printed circuit board 22. Chipower Technology (China) Model No. CE8808 such can serve as the low voltage detector. It is understood that the soil moisture audio alarm assembly can be arranged to be powered by line voltage instead of by batteries.

Although the invention is illustrated and described herein with reference to specific embodiments, the invention is not intended to be limited to the details shown. Rather, various modifications may be made in the details within the scope and range of equivalents of the claims and without departing from the invention.

What is claimed:

1. A plant pot having a soil moisture audio alarm comprising:
a container adapted to hold soil and a plant; and
a soil moisture audio alarm assembly mounted to said container and including:
(a) a soil moisture sensor adapted to be embedded in the soil held in said container for:
(1) sensing the degree of moisture of the soil, and
(2) providing a moisture output signal representative of the degree of moisture of the soil,
(b) an audio signal source for transmitting audio signals when activated,
(c) audio alarm means, responsive to signals transmitted from said audio signal source, for sounding an audio alarm, and
(d) control circuit means, responsive to the moisture output signal, for:
(1) sensing the level of the moisture output signal,
(2) activating said audio signal source when the level of the moisture output signal represents the moisture of the soil falling below a prescribed threshold level, and
(3) conducting the audio signals transmitted from said audio signal source to said audio alarm means.

2. A plant pot according to claim 1 wherein:
(a) said audio signal source is an electronic recording of music, and
(b) said audio alarm means is a speaker.

3. A plant pot according to claim 2 wherein said container includes:
(a) a first shell to which said soil moisture audio alarm assembly is mounted, and
(b) a second shell fitted within said first shell adapted to hold the soil and the plant.

4. A plant pot according to claim 3 further including a soil drainage retainer screen spaced from the bottom of said second shell to define a reservoir for water draining from the soil.

5. A plant pot according to claim 1 further including a light sensor for:
(a) sensing the degree of ambient light in the vicinity of said plant pot, and
(b) providing a light output signal representative of the ambient light in the vicinity of said plant, and
wherein said control circuit means include a disabling circuit, responsive to the light output signal of said light sensor, for preventing activation of said audio signal source when the light output signal falls below a prescribed level.

6. A plant pot according to claim 5 wherein:
(a) said audio signal source is an electronic recording of music, and
(b) said audio alarm means is a speaker.

7. A plant pot according to claim 6 wherein said container includes:
(a) a first shell to which said soil moisture audio alarm assembly is mounted, and
(b) a second shell fitted within said first shell adapted to hold the soil and the plant.

8. A plant pot according to claim 5 further including a soil drainage retainer screen spaced from the bottom of said second shell to define a reservoir for water draining from the soil.

9. A plant pot according to claim 2 wherein said control means activate said audio signal source periodically.

10. A plant pot according to claim 6 wherein said control means activate said audio signal source periodically.

11. A plant pot according to claim 4 wherein said control means activate said audio signal source periodically.

12. A plant pot according to claim 8 wherein said control means activate said audio signal source periodically.

13. A plant pot according to claim 4 wherein said soil moisture sensor extends through said water reservoir and the portions of said soil moisture sensor that extend through said water reservoir have a coating that prevents said moisture sensor from sensing and responding to water in said water reservoir.

14. A plant pot according to claim 8 wherein the portions of said soil moisture sensor that extend through said water reservoir have a coating that prevents said soil moisture sensor from sensing and responding to water in said water reservoir.

15. A plant pot having a soil moisture audio alarm comprising:
a container adapted to hold soil and a plant; and
audio soil moisture level indicator means mounted to said container and including:
(a) a soil moisture sensor adapted to be embedded in the soil held in said container for sensing the degree of moisture of the soil and providing a low-moisture indication when the moisture of the soil falls below a prescribed moisture level,
(b) an audio alarm for sounding, when energized, an alarm when the moisture of the soil held in said container falls below the prescribed moisture level, and
(c) control circuit means between said soil moisture sensor and said audio alarm and responsive to a low-moisture indication of said soil moisture sensor for energizing said audio alarm.

16. A plant pot according to claim 15 wherein said container includes:
(a) a first shell to which said audio alarm and said control circuit means are mounted, and
(b) a second shell fitted within said first shell adapted to hold the soil and the plant, and
said plant pot further Includes a soil drainage retainer screen spaced from the bottom of said second shell to define a reservoir for water draining from the soil.

17. A plant pot according to claim 15 further including a light sensor for:
(a) sensing the degree of ambient light in the vicinity of said plant pot, and
(b) providing a light output signal representative of the ambient light in the vicinity of said plant, and
wherein said control circuit means include a disabling circuit, responsive to the light output signal of said light sensor, for preventing energizing of said audio alarm when the light output signal falls below a prescribed level.

18. A plant pot according to claim 16 further including a light sensor for:
(a) sensing the degree of ambient light in the vicinity of said plant pot, and
(b) providing a light output signal representative of the ambient light in the vicinity of said plant, and
wherein said control circuit means include a disabling circuit, responsive to the light output signal of said light sensor, for preventing energizing of said audio alarm when the light output signal falls below a prescribed level

19. A plant pot according to claim 16 wherein said soil moisture sensor extends through said water reservoir and the portions of said soil moisture sensor that extend through said water reservoir have a coating that prevents said soil moisture sensor from sensing and responding to water in said water reservoir.

20. A plant pot according to claim 18 wherein said soil moisture sensor extends through said water reservoir and the portions of said soil moisture sensor that extend through said water reservoir have a coating that prevents said soil moisture sensor from sensing and responding to water in said water reservoir.
